(19) United States
(12) Patent Application Publication
(10) Pub. No.: US 2005/0094792 A1
(43) Pub. Date: May 5, 2005

(54) Central-office-enabled muting of telephones

(76) Inventors: Charles William Berthoud, Bethlehem, PA (US); James Thomas Cargo, Bethlehem, PA (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/675,570

(22) Filed: Sep. 30, 2003

(51) Int. Cl. H04M 3/42

(52) U.S. Cl. 379/202.01

(57) ABSTRACT

Disclosed are methods, systems and services that utilize telephone system Central Office recognition of specifically programmed user-initiated signaling to turn on and to turn off one or more muting functions for transmission and/or receipt functions of the user's or another's telephone. Particular embodiments include the use of such methods, systems and services in multi-party conference calls, including where a leader of such conference call can, by pressing keypad commands, actuate the enabling and disabling of transmission and/or receipt paths for one or more other members of the conference call.

### FIELD OF THE INVENTION

This invention relates generally to the field of control of transmission of voice and other sounds from the speaker of a telephone to the other parties in a telephone call. More particularly, this invention relates to a system and service for user-initiated signaling to the telephone system central office to turn on and to turn off a muting function for either transmission or receipt functions of the user's or of another's telephone.

### BACKGROUND OF THE INVENTION

Many conventional, wire telephones are equipped with a self-contained mute function. Some cellular-type telephones also have a self-contained mute function. When such mute function is activated by the person operating the telephone during a telephone call, the transmission of voice and other sounds from that person to the other party or parties of the telephone call is ceased. This typically is effectuated by a simple on/off switching operation controlled by the muting button or switch, and integral with the telephone unit itself. The person may wish to switch on the mute function in order to have a private conversation with someone in his or her presence, or to reduce distraction of background noise to the other parties involved in the phone call, such as in a multi-party conference call. While the mute function is operating, the person nonetheless can listen to the telephone conversation. Then, at an appropriate time, the person deactivates the mute function, the switch within the phone unit returns to its non-mute positions so that voice transmission is restored, and the person's voice thereafter is heard by the other party or parties of the telephone call.

Thus, the muting function is of value to many telephone users, particularly during conference calls, and more particularly when one party is experiencing undesirable background noise that unnecessarily hampers the listening by other parties to the conference call. The muting function, when implemented by the user to cease the transmission of his/her voice and unwanted background noise, is more specifically referred to as “self-muting.” When a leader of a conference call decides to turn off one or both of the transmission or receipt signal paths to a particular user other than himself/herself, this is more specifically referred to as “on hold.” However, for the purposes of this disclosure, both specific operations remain within the general category of muting.

Most cellular telephones, as well as many lower-priced consumer grade telephones, are not equipped with a self-contained self-muting function. This can lead to disturbing results when one person is engaged in a telephone conversation and there is appreciable background noise. Background noise can be especially troublesome for traveling businesspersons using a cellular telephone to participate in a conference call. When this person need only listen to the others in the conference call for most of the call's duration, and this person is in an airport, train station, or other space where there is substantial background noise, a muting function would be extremely desirable. Such muting function would alleviate the transmission of the background noise, allow the person to listen to the entire conference without transmitting disturbing background noise, yet the on/off feature would allow that person to speak when he so desired to the others in the conference call.

Also, in certain situations in a multi-party conference call, a leader of the conference call may want to mute the transmission of certain parts of the conference call to one or more persons' telephones whilst speaking on a particular matter to other persons (i.e., place the former person(s) on hold). In such circumstance, there is a need to mute the receipt path to those parties to be excluded from that part of the call. Alternately, the leader may want to mute excessive background noise or other sounds from one or more participants in the conference call. In such circumstances, there is a need to mute the transmission path from such one or more participants.

In contrast to conventional, wire telephones that are equipped with a self-contained, or integral mute function, the present invention utilizes the Central Office call switching facility of the telephone system that is handling the standard or conference call in need of a mute function. There are a number of approaches to design and operation of Central Office switching facilities. Some of these are described in the following patent and non-patent references: U.S. Pat. No. 3,733,439 to Verhille et al.; U.S. Pat. No. 4,038,638 to Hwang; U.S. Pat. No. 4,173,713 to Giesken et al.; U.S. Pat. No. 5,544,163 and U.S. Pat. No. 6,522,646 to Madonna; U.S. Pat. No. 6,055,237 to Hebert et al., and “Mathematical Theory of Connecting Networks for Telephone Logic” by V. E. Benes, Academic Press, 1965, the entire text, and particularly Chapter 4. These patents and non-patent references, and all other patent and non-patent references cited in this disclosure, are hereby incorporated by reference into this disclosure.

The presently used self-contained muting functions in wire and cellular telephones are not capable of all muting functions for control of telephone calls, particularly of multi-party conference calls. Thus, there is a need in the field of telephone routing systems to provide such capabilities.

### SUMMARY OF THE INVENTION

Muting function methods of operation and service are described herein; these are enabled at the Central Office (“CO”) of a telephone system. These methods of operation and service are especially useful for mobile telephones, for wire telephones and for cordless telephones that are not equipped with an integral, or self-contained, muting function.

One embodiment of the present invention is a muting service offered by the telephone company that operates the Central Office (“CO”) through which the telephones of a telephone conversation are routed. The telephone company offers one or more variants of a central office-enabled muting function service to which users may subscribe. A user subscribes to one of various types of the muting function service for a specified additional monthly fee. Then the telephone company adds the muting function service to that user's telephone number in its Central Office (“CO”) database. As discussed in detail below, the adding of this capability includes the recognition of specific messages made by the user's keypad strikes as instructions to turn a mute function on or off.

Thereafter, a user subscribing to a basic type of the service of the present invention activates and deactivates the CO-enabled muting function as follows. When, during a telephone call, the user wants to activate a muting function to prevent the other party or parties in a telephone call from hearing sound from the user's telephone, the user presses a designated keypad, for instance the number key “1” or “#.” As for other keys, pressing such key generates a specific dual tone multiple frequency (“DTMF”) that is transmitted to and detected at the CO. Upon receipt and processing of this signal from the user, which involves recognition of this signal as a signal to enable the muting, muting is enabled at the CO. Typically, the muting is enabled by suppressing the transmission signal from the user at the CO. Then, the user wants to disable the muting function, the user presses a second key, such as the “2” keypad, or “#” again, this signal is sent to, received and processed by the CO, and the CO disables the muting function.

As desired, the user can repeat the enable-mute and disable-mute signals repeatedly during a single telephone call. Also, in another embodiment of this type of service, the same keypad can be used to enable and then disable the muting function. In this case, a simple sequential on/off command would be effectuated at the CO based on receiving sequential signals. In another embodiment of this type of service, two non-numeric keys are used to signal the CO to enable and disable the muting function.

Another type of CO-enabled service of the present invention is the use of this service during a conference call that is introduced by a telephone operator. For instance, in such situations the operator instructs the users, prior to or at the start of the conference call, which keystrokes enable and disable the muting functions. Typically these are for self-muting operations, but the operator-assisted, operator-instructed calls can also provide for control by one or more designated leaders of a telephone conference call. The designated leader(s) is/are able to activate and deactivate both the receipt and the transmission paths of one or more participants of the telephone conference call by pressing appropriate keypads or combinations of keypads.

Another type of CO-enabled service of the present invention is effectuated without the input of an operator, and is controlled by one or more designated leaders of a telephone conference call. As above, the designated leader(s) is/are able to activate and deactivate both the receipt and the transmission paths of one or more participants of the telephone conference call by pressing appropriate, designated keypads or combinations of keypads.

The above-described muting function services, methods of operation, and systems also can be implemented in a customer premises equipment (“CPE”) system, such as a private branch exchange (PBX), which often is referred to interchangeably as private, automatic branch exchange (PABX). Such branch exchange systems commonly are utilized in enterprises that include manufacturing facilities such as mills and factories, and in hotels, large businesses, and government offices. Such branch exchange systems provide communications access to and from individual employees of the particular enterprise, and typically include external communications access. Providing centrally operated muting functions may be especially useful in such branch exchange systems, particularly where some telephones of the system are multi-zone type cordless office telephones, and where the users of such telephones use the telephones in noisy zones, such as in a steel mill, a factory floor, a hotel lobby, or a casino floor.

The above-described muting function services, methods of operation, and systems are especially useful when one or more of the telephones used in a two-party or in a multi-party conference call is a mobile, such as a cellular, telephone.

These and other features and advantages of the new methods, services and systems of the present invention will become apparent upon consideration of the following detailed description of the invention and the figures related thereto, and the appended claims.

### BRIEF DESCRIPTION OF THE DRAWINGS

FIG. 1 is a diagrammatic representation of two telephone users, or parties, designated A and B, who are engaged in a telephone call that uses one embodiment of the method and system of the present invention.

FIG. 2 provides a diagrammatic representation of the routing of a telephone call between telephone users A and B who are engaged in a telephone call in which user A has muted his/her transmission of sounds from his/her telephone to the telephone of user B.

FIG. 3 is a diagrammatic representation of five telephone users, or parties, A, B, C, D and E, involved in a telephone conference call in which conference call leader A_{L} has muted the receipt of the entire conference call voices and sounds to users C and D, but in which users C and D can still speak into their telephones and be heard by other members of the conference call.

FIG. 4 is a diagrammatic representation of five telephone users, or parties, A, B, C, D and E, involved in a telephone conference call in which conference call leader A_{L} has muted the receipt of the entire conference call to user E, and also has muted the transmission of voice of user E to the other members of the conference call.

### DETAILED DESCRIPTION OF THE INVENTION

As used throughout this specification, including the claims, the terms “sound transmission,” “speech transmission,” and “voice transmission” are meant to include, without being limited to, the movement of sound waves from a source of such sound, speech, or voice, through a medium, such as air. As used throughout this specification, including the claims, the terms “sound signal transmission,” “speech signal transmission,” and “voice signal transmission” are meant to include, without being limited to, the movement of specifically patterned electrical signals, radio waves and other forms of energy conduction, from a source of said sound transmission through a medium, such as a copper wire or air, wherein such specifically patterned forms of energy conduction are convertible to sound waves at a typical electromagnetic or electrostatic or other type of speaker.

As used throughout this specification, including the claims, the terms “sound reception,” “speech reception,” and “voice reception” are meant to include, without being limited to, the receipt of sound waves by a sensor of said sound waves, typically after passage of such sound waves through a medium, such as air. As used throughout this specification, including the claims, the terms “sound signal reception,” “speech signal reception,” and “voice signal reception” are meant to include, without being limited to, the receipt of specifically patterned electrical signals, radio waves and other forms of energy conduction, from a medium, such as a copper wire or air, to a receiving converting device, such as a telephone receiver, wherein such specifically patterned forms of energy conduction are convertible to sound waves at a typical electromagnetic or electrostatic or other type of speaker.

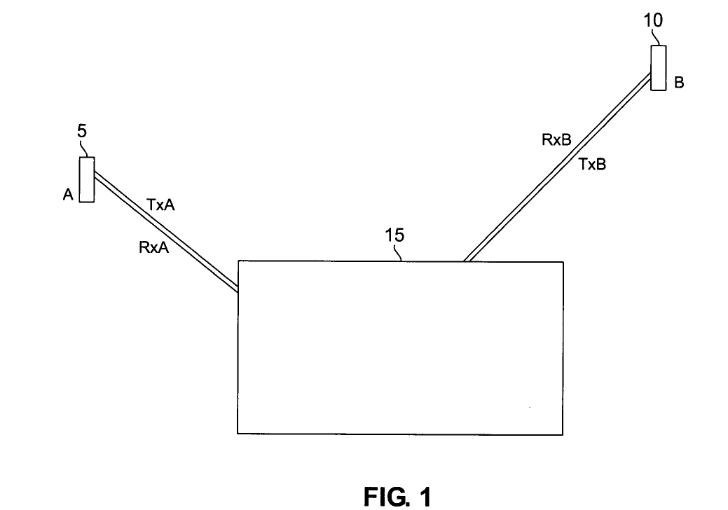

FIG. 1 is a diagrammatic representation of two telephone users, or parties, designated A and B, who are engaged in a telephone call. The voice signals (which may include undesirable background sounds or voices) are routed through a Central Office, 15 interchange of the telephone company that is providing the telephone service. Without any use of the present invention, the Central Office, 15, uses routing means as are typical of the industry to maintain the voice signal transmissions between users A and B for the duration of their call.

As is a standard convention for telephone systems, each telephone connection to a party has a duplex connection. That is, under normal conditions sound (in the form of electrical signals) is transmitted by one party, for instance A, at the same time that sound communicated into the telephone speaker of user B's telephone is transmitted to party A. For each telephone, the voice signal transmission from that telephone to the Central Office, 15, is designated as the transmitting signal, Tx(followed by the respective telephone user's designation), and the voice signal transmission from the Central Office, 15, to that telephone is designated as Rx(followed by the respective telephone user's designation). Thus, two lines, one shown as TxA, the other shown as RxA, connect user A's telephone, 5, to the Central Office, 15. These indicate, respectively, the duplex transmission by and reception into paths for telephone 5. Similarly, two lines, one shown as TxB, the other shown as RxB, connect user B's telephone, 10, to the Central Office, 15. These indicate, respectively, the duplex transmission by and reception into paths for telephone 10. For A's voice to be transmitted to B, sound converted to electrical (or radio wave) energy by telephone 5 is transmitted along TxA path to the Central Office, 15, where it is connected to an outgoing reception path, namely RxB, at the end of which the electrical (or radio wave) energy is converted to sound waves at B's telephone, 10.

As inferable from the above discussion, it is recognized that the sound signals may be transmitted from a particular telephone unit, depending on the telephone being used, by wire, by wireless, or by a combination of wire and wireless mechanisms.

As noted, under normal operating conditions, all sound within the standard transmissible detection limit of the microphone of user A's telephone is transmitted to the speaker of user B's telephone, and vice versa, via routing through the Central Office, 15.

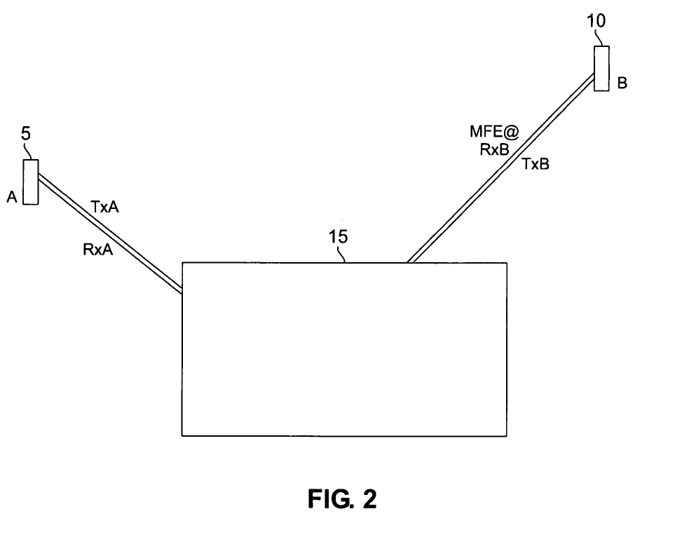

FIG. 2 provides a diagrammatic representation of the routing of a telephone call between telephone users A and B who are engaged in a telephone call that uses one embodiment of the method and system of the present invention. When, for instance, during the telephone call with user B, user A wants to block sound transmission from his/her telephone to user B, user A presses a keypad, for instance, number “1.” This generates a unique dual tone multiple frequency (“DTMP”) which is recognized at the Central Office, 15, as a signal to turn on the muting function.

This signal activates a mechanism in the Central Office, 15, that prevents TxA signals from being routed to RxB. One mechanism to achieve this is to add attenuation to the path of TxA in the Central Office, 15, thereby reducing the amplitude of user A's voice signal so as to not be heard by user B. Another mechanism is to provide an electronic switch that breaks the path of TxA in the Central Office, 15. One of these, or other mechanism to mute the sounds from user A to user B is effectuated within the Central Office, 15, so that the sounds input into user A's phone, 5, which are received by Central Office, 15, are not transmitted from there to user B via RxB. This is shown in FIG. 2 by the abbreviation “MFE@” (standing for “mute function on”) beside path RxB.

It is noted that the specific mechanism to enable the muting function will in part depend on the physical and programming nature and limitations of a particular Central Office switching facility. The references cited in the “Background of the Invention,” above, provide an understanding of some types of switching mechanisms, including more modern digital switching. For a particular Central Office switching facility, one of ordinary skill in the art can determine appropriate means to implement the methods, systems and services of the present invention. For instance, not to be limiting, for one Central Office switching facility adding an attenuation feature to enable muting may be appropriate, whereas in a second Central Office switching facility implementing digital control means to switch off a sound signal transmission or a sound signal receipt path may be more appropriate. Without limiting the scope of the disclosure and the claims appended hereto, and recognizing the high level of the art in electronics, two examples of means of attenuation are: 1) the addition of a resistive element in the Tx/Rx path; and 2) a gain reduction in the Tx/Rx path.

When user A wants to deactivate, or disable, the CO-enabled muting of his/her telephone's TxA transmission sounds to user B, user A presses the telephone company's designated mute-disabling keypad, for instance keypad numeral “2.” (Note: the effect is not shown in FIG. 2, which only shows the muting function enabled for user A's sound transmission to user B.) The choice of which keypads to press to enable and disable the muting function is arbitrary. In fact, the same keypad can be used to sequentially enable and disable the muting function.

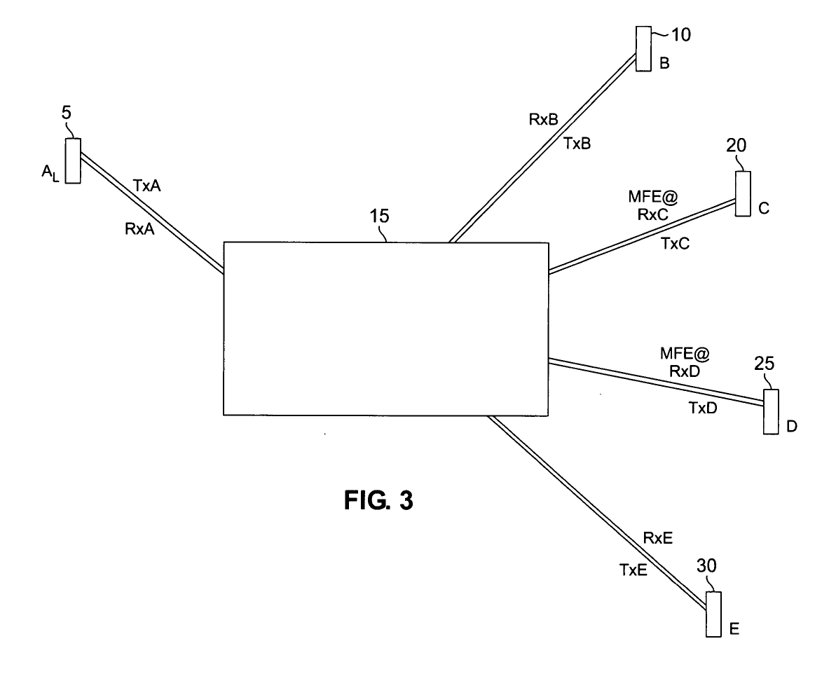

FIG. 3 is a diagrammatic representation of five telephone users, or parties, A, B, C, D and E, who are members of a telephone conference call that uses one embodiment of the method and system of the present invention. Member A uses telephone 5, member B uses telephone 10, member C uses telephone 20, member D uses telephone 25, and member E uses telephone 30. As is the standard convention for telephone systems, each telephone connection to a party has a duplex connection. That is, under normal conditions sound (or other information) is simultaneously transmitted by one party, for instance A, while simultaneously sound communicated into speakers at other telephones in operation, by members B, C, D and E of the conference call, is received by party A and the other conference call members. For each telephone's voice signal transmissions between itself and the Central Office, 15, signal from the telephone to the Central Office, 15, is designated as the transmitting signal, Tx(followed by the respective telephone user's designation), and the signal from the Central Office to that telephone is designated as Rx(followed by the respective telephone user's designation). As noted for the embodiment of FIGS. 1 and 2, it is recognized that the sound signals may be transmitted, depending on the telephones being used, by wire, by wireless, or by a combination of wire and wireless mechanisms.

In FIG. 3, user A is shown as “A_{L}” because user A is arbitrarily designated as the conference call “leader.” That is, in this embodiment user/leader A has either initiated the conference call or has been designated by the party initiating the call as the conference call leader. As such, user/leader A has control of who can be muted during the telephone call. During one part of the conference call, part of which is depicted in FIG. 3, user/leader A determines that both user, or member, C and user, or member D, should not receive the conference call voice (or voice and sound) transmission that is about to transpire. To accomplish this, user/leader A presses the appropriate keypads to enable the “receipt of conference call” muting function. By so pressing the appropriate keypads, RxC and RxD are disabled so that no sounds (voice or otherwise) is sent to and received by C and D. This is shown in FIG. 3 by the abbreviation “MFE@” (standing for “mute function on”) beside paths RxC and RxD.

Later during the conference call, possibly even after one or both of B or E have left the conference call, if user/leader A wants to restore the receipt of sound transmission to C and D, user/leader A then presses the appropriate series of keys to do so (result not shown in FIG. 3). The choice of which keypads to press to enable and disable the muting function is arbitrary, but once determined by the telephone company, are to be adhered to in order to obtain the desired results.

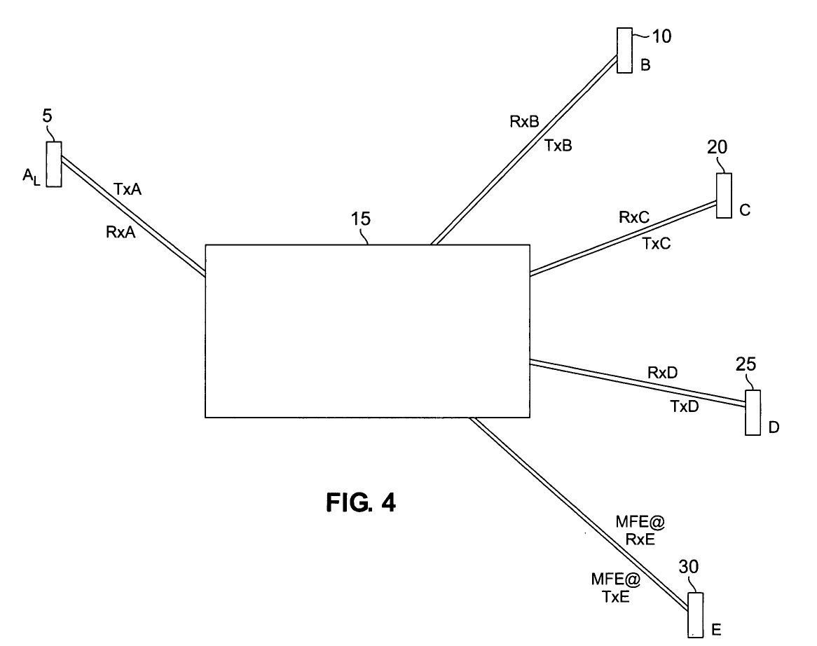

FIG. 4 is a diagrammatic representation of five telephone users, or parties, A, B, C, D and E, involved in a telephone conference call in which conference call leader A_{L} has muted the receipt of the entire conference call to user E, and also has muted the transmission of voice of user E to the other members of the conference call. The same duplex connection for each telephone, as described above, applies in this example, and as described above in FIG. 3, member A uses telephone 5, member B uses telephone 10, member C uses telephone 20, member D uses telephone 25, and member E uses telephone 30.

For each telephone's voice signal transmissions between itself and the Central Office, 15, signal from the telephone to the Central Office, 15, is designated as the transmitting signal, Tx(followed by the respective telephone user's designation), and the signal from the Central Office to that telephone is designated as Rx(followed by the respective telephone user's designation). As noted for the embodiments of FIGS. 1, 2 and 3, it is recognized that the sound signals may be transmitted, depending on the telephones being used, by wire, by wireless, or by a combination of wire and wireless mechanisms.

Further, as for FIG. 3, user A is shown as “A_{L}” because user A is arbitrarily designated as the conference call “leader.” That is, in this embodiment user/leader A has either initiated the conference call or has been designated by the party initiating the call as the conference call leader. As such, user/leader A has control of who can be muted during the telephone call. During one part of the conference call, part of which is depicted in FIG. 4, user/leader A determines that member E should, for a period of time, neither receive the conference call voice (or voice and sound) transmission that is about to transpire, nor should member E be able to transmit his voice into the conference call for that period. For example, the conference call could be to conduct a job interview with E, and after the interview has concluded, user/leader A wants to confer with members B, C and D to hear opinions as to whether to hire, what salary to offer, etc., to reach final decisions, and to return to E to either make an offer or decline to do so.

To accomplish the desired muting, user/leader A presses the appropriate keypads to enable muting function for the “receipt of conference call” and the “transmission to conference call” for member E. By so pressing the appropriate keypads, RxE is disabled so that no sounds (voice or otherwise) of the conference call is sent to and received by E. Also, and TxE is disabled so that no sounds (voice or otherwise) from E are heard by other members of the conference call. This is shown in FIG. 4 by the abbreviation “MFE@” (standing for “mute function on”) beside paths RxE and TxE.

Later during the conference call, possibly even after some of the other members have left the conference call, user/leader A presses the appropriate series of keys to restore paths RxE and TxE. User/leader A, or another member of the conference call, then can converse with member E, such as to provide the results of the decision (i.e., whether a job offer will be made, etc.) (The result of restoration of RxE and TxE is not shown in FIG. 4).

The reasons for muting the sound transmission signal from one or more members of a multi-party telephone call include the desire to eliminate background noise emanating from that person's telephone and disturbing the hearing ability of other members of the conference call. This is especially useful when one of the members of the call is in a noisy airport, train station, steel mill, factory, or the like. When only the sound transmission is muted, the person so muted still can listen to the other parties, or members, who are speaking in the conference call.

As noted during the discussion of FIG. 3, the choice of which keypads to press to enable and disable the muting function is arbitrary. The following is but one of a multitude of sequences and command structures that can provide a user/leader with instructions that are implemented to provide instructions to the Central Office so the Central Office actuates the enable and disable muting functions for a two-party call, or for a multi-party conference call. As is expected, particularly for Central Office computerized switching facilities, when implementing the mute function system and service of the present invention, entering the instruction sequences and command structures by which users will send instructions to the Central Office is more efficiently achieved by development of computer programs that include such instruction sequences and command structures.

The following table, which is not meant to be limiting in any way, provides one example of keystroke and data entry instructions that the user/leader (or a party designated by that person) enters to set up a conference call during which the muting function can be utilized, and the steps to utilize such function during the call:

| Step/Keystrok | Display | Comments |
|---|---|---|
| Bring up menu | Enter first number. | User/leader “Alan” can enter a full |
| option for | | phone number, or scroll through |
| conference call. | | phone book to select first member. |
| (Varies with | | |
| phone.) | | |
| “Betty” | “Betty” = 1 | Betty will be designated as first |
| Enter | Enter second | Enter or select a second member of |
| “Charley” | “Charley” = 2 | Charley will be designated as 2^{nd} |
| Enter | Enter third number. | Enter or select a third member of |
| | | call. |
| 1-409-123- | 1-409-123-4567 = 3 | This telephone number is 3^{rd} |
| 4567 | | member. |
| Enter | Enter fourth | If no more members, press enter. |
| | number. | |
| Enter | More options, or | Since no other options (such as to |
| | press CALL to start | mute from the start) are wanted, |
| | | press [symbol] |
| CALL | Calling party 1. | Calls will be placed sequentially to |
| | Calling party 2. | each member. Once a member is |
| | Calling party 3. | connected, next number is dialed |
| | | automatically. |
| | | After several minutes with all |
| | | parties transmitting and receiving |
| | | to all others, |
| | | Alan wants to speak to Betty and |
| | | Charley without Dave (at 409-123- |
| | | 4567)- [symbol] |
| 3 | Mute Member 3 for: | Alan presses 3 to mute Dave |
| | Talk = 1 | totally (so Dave can neither hear or |
| | Listen = 2 | be heard on the call. After |
| | Total = 3 | finishing private part of call, Alan |
| | | wants to return Dave to |
| | | [symbol] |
| 3 | Member 3 = Total | Alan presses 4 to return Dave |
| | Mute | completely to hear and be heard. |
| | 4 = Normal | |
| | 5 = Listen, not talk | |
| | 6 = Talk, not listen | |
| 4 | Member 3 = Normal | As call finishes, users simply hang |
| | | up to end their respective |
| | | participations. |

In the above table, the telephone used by the leader who directs the conference call is capable of receiving text messages, and the CO is programmed to provide the appropriate text messages to the leader's telephone based on the keypads the user presses. Thus, in such embodiments, the CO sends text messages to prompt and inform the leader. However, standard telephones can be used to provide appropriate communications with a CO having the muting features of the present invention for conference calls. In such embodiments a greater reliance is placed upon written or other instructions independent of the display screen on the telephone since responsive screen messages are lacking.

In certain embodiments, a party that is being muted may be provided with a periodic auditory tone or message, or a message on the telephone LED screen, indicating the status of the muting. Also, other parties not muted could receive a specified auditory tone or tone pattern that would be sufficiently non-intrusive so as not to disturb the telephone conversation, but would be a reminder of the status of a call member.

As noted in the Summary section, supra, the above-described muting function services, methods of operation, and systems can be used in operator-assisted telephone conference calls. For instance, the operator instructs the users, prior to or at the start of the conference call, as to which keystrokes (when pressed before or during the call, depending on the system) enable and disable the muting functions. Typically these are for self-muting operations. For instance, the operator can instruct each participant of the telephone conference call to press the “#” keypad once to self-mute (i.e., enable the mute of transmission), and a second “#” (or a different keypad) to disable the self-mute function.

In this and in other embodiments, the operator-assisted, operator-instructed calls also provide for control by one or more designated leaders of a telephone conference call. The designated leader(s) selectively activates and deactivates both the receipt and the transmission paths of one or more participants of the telephone conference call by pressing appropriate keypads or combinations of keypads. Some variants of these calls with leaders provide for all control to be had by one leader or by several leaders. Such variants preclude the ability of a particular participant to self-mute.

As noted earlier, the above-described muting function services, methods of operation, and systems are especially useful when one or more of the telephones used in a two-party or in a multi-party conference call is a mobile, such as a cellular, telephone. Another area for implementation of the present invention is in such branch exchange systems, particularly where the users of such telephones use the telephones in noisy zones, such as in a steel mill, a factory floor, a hotel lobby, or a casino floor. In such embodiments and uses, particularly in which few keystrokes are used to enable and disable the desired features, the personnel, once accustomed to the use of such keystrokes, can repeatedly and easily operate the system, even without screen prompting or guidance. Further, in certain embodiments, the system, or a particular user's telephone, is customized to provide a desired combination of actions with a single keypad stroke. For instance, in a noisy steel mill or factory, pressing a single keypad enables the self-muting (of the Tx) and simultaneously increases the volume of the Rx, so this user is in a better position to listen to the conversation given a high volume of background noise.

Other variations of the present invention provide for the ability to create keypad shortcuts, and/or to preprogram an enablement/disablement regime for a conference or other type of call. Another optional feature is to provide a “disconnect” function for conference calls, so a user/leader can totally disconnect a party if so desired.

While the preferred embodiments of the present invention have been shown and described herein, it is apparent that such embodiments are provided by way of example only. Numerous variations, change and substitutions will occur to those of ordinary skill in the art without departing from the invention herein. Accordingly, it is intended that the invention be limited only by the spirit and scope of the appended claims.

1. A method to enable and disable a first muting function, to mute sound signal transmission between at least one telephone and another selected telephone during a multi-telephone conference call, said method comprising implementing a system in a central office servicing said at least one telephone, which comprises establishing a keypad signal recognition system wherein a specific keypad actuation during said telephone call instructs said central office to enable said first muting function and wherein a second keypad actuation during said telephone call instructs said central office to disable said first muting function.

2. The method of claim 1 wherein said keypad actuation is implemented on said at least one telephone.

3. The method of claim 1 wherein said enabling of said muting function is by attenuation of said sound signal transmission from said another selected telephone at said central office.

4. The method of claim 1 wherein the multi-telephone conference call includes a plurality of additional telephones that are connected in communication with said at least one telephone and said at least one least one telephone is enabled to mute said additional telephones.

5. The method of claim 1 wherein the keypad signal recognition system is set such that only a keypad actuation on said at least one telephone during said telephone call enables said first muting function.

6. The method of claim 1 wherein the keypad signal recognition system is set such that only a keypad actuation on said another selected telephone during said telephone call enables said first muting function.

7. The method of claim 1 wherein the keypad signal recognition system is set such that only the keypad actuation on said at least one telephone during said telephone call disables said first muting function.

8. The method of claim 1 wherein the keypad signal recognition system is set such that only the keypad actuation on said another selected telephone during said telephone call disables said first muting function.

9. The method of claim 1 wherein said another selected telephone is a mobile telephone.

10. A telephone system central office-enabled muting service, comprising:
a. establishing a keypad recognition system that recognizes each of one or more keypad signals, or combination of keypad signals, from a telephone system user's telephone as a user-provided instruction to enable or to disable one or more voice signal transmission and voice signal receipt muting features;
b. providing one or more types of central office-enabled muting services to one or more users of said telephone system, wherein each of said one or more types of services provides a specific set of muting options to said one or more users thereof; and
c. for said user provided with one of said one or more types of central office-enabled muting services, providing ongoing actuation of muting options within said specific set based on receipt in said central office of said one or more keypad signals, or combination of keypad signals, said signals, or combination of keypad signals, being user-provided instructions, to enable or to disable one or more voice signal transmission and voice signal receipt muting features.

11. The telephone system central office-enabled muting service of claim 10, wherein said keypad recognition system includes signals, or combination of keypad signals, that provide for one or more conference call leaders in a telephone conference call to send instructions to said central office that actuates the enablement and disablement of a muting function selected from a group consisting of: muting the sound transmission signals from one or more members of said conference call; muting the sound receipt signals from one or more members of said conference call; and muting the sound transmission signal and the sound receipt signal, at the same time, from one or more members of said conference call.

12. The telephone system central office-enabled muting service of claim 10 wherein said user's telephone is a mobile telephone.

13. The telephone system central office-enabled muting service of claim 10, wherein the pressing of a single keypad is programmed to simultaneously enable muting of voice signal transmission and increase amplitude of voice signal receipt.
